(19) United States
(12) Patent Application Publication
(10) Pub. No.: US 2008/0177619 A1
(43) Pub. Date: Jul. 24, 2008

(54) INFORMATION DECISION APPARATUS, METHOD THEREOF AND COMPUTER-READABLE RECORDING MEDIUM THEREOF

(75) Inventor: Yasuo Sugahara, Kawasaki-shi (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/053,405

(22) Filed: Mar. 21, 2008

Related U.S. Application Data
(62) Division of application No. 09/375,005, filed on Aug. 16, 1999.

(30) Foreign Application Priority Data
Dec. 14, 1998 (JP) 10-355046

(51) Int. Cl. G06Q 10/00; G06Q 30/00

(52) U.S. Cl. 705/10; 705/14

(57) ABSTRACT

The present invention provides an information decision apparatus including the following parts: A target transactor finding part finds target transactors in accordance with promoting product information so as to focus only on potential transactors who may be interested in buying the promoting product; A transaction tendencies analyzing part analyzes transactor's tendencies based on a transactor's purchasing history for each of the target transactors so as to examine purchasing trends of the target transactors; An information decision part decides on appropriate information that fits the transactor's tendencies analyzed by the transaction tendencies analyzing part so as to produce an attractive information corresponding to each target transactor.

### BACKGROUND OF THE INVENTION

1. Field of the Invention

The present invention generally relates to information decision apparatuses, methods thereof and recording media thereof for making decisions based on information, and more particularly to an information decision apparatus, a method thereof and a recording medium thereof for analyzing a customer's purchasing tendencies from the customer's purchasing history and making a decision to offer suitable products to the customer.

Recently, especially in the computer industry, new products have been developed quickly in a short term. Thus, the product cycle of the computer becomes shorter. Accordingly, a demand cycle to replace computers becomes a short-term cycle. Generally, customers decide when and with which computer they should replace their current computers. However, it is difficult for a customer to choose a most appropriate computer from a huge computer market in which computer products change quickly. Therefore, to help a customer make a decision, it is preferable to inform the customer of appropriate information of new products that fit the customer's purchasing tendencies. In addition, instead of handling customers' old computers as industrial waste, it is preferable to recycle those used computers that can be still used as products.

2. Description of the Related Art

In a conventional distribution system, direct mail to promote new product information is sent to customers who purchased products before. Even in the computer industry, direct mail is used as a sales promotion. Generally, direct mail is sent to all customers every time when new products are announced publicly.

On the other hand, old products replaced with new products are collected by manufacturers that produce those new products or by organizations listed in magazines or the like who recycle the collected used products.

However, the conventional distribution system has the following disadvantages:

The direct mail including new product information (or new service information) often does not focus on a customer's interest. The information in the direct mail may be useless for the customers and thus the customers do not respond to the direct mail. Therefore, the sales promotion for new products by the direct mail is not effective. Although there are information providers providing selected information for customers, the customers' voluntary queries to the information providers are required. Therefore, the direct mail can not achieve effective sales promotion.

In addition, it costs to dispose of unwanted products replaced with new products. Also, computer waste is an industrial waste. It is preferable to utilize limited resources effectively; that is, it is desired to recycle unwanted products resulting from the replacement. However, it is quite difficult to maintain used computer businesses because old models of computers tend to dramatically decrease in price in a short term. Thus, computer manufacturers have some responsibility to manage this problem related to computer waste disposal.

### SUMMARY OF THE INVENTION

It is a general object of the present invention to provide an information decision apparatus, a method thereof and a recording medium thereof for making decisions based on information in which the above-mentioned problems are eliminated.

A more specific object of the present invention is to provide an information decision apparatus, a method thereof and a recording medium thereof for analyzing a customer's purchasing tendencies from the customer's purchase history information; finding only potential customers who may replace their current computers with new computer models; and making a decision to offer suitable products to the customers.

Another object of the present invention is to provide an information decision apparatus, a method thereof and a recording medium thereof for maintaining information of collected used computers and finding potential customers, who may purchase the used computers, from a customer information database including the customer's purchasing tendencies.

The above objects of the present invention are achieved by an information decision apparatus including: a transaction tendencies analyzing part for analyzing transactor's tendencies based on a transactor's transaction history; and an information decision part for deciding on appropriate information that fits the transactor's tendencies analyzed by the transaction tendencies analyzing part.

According to the present invention, the decided-on appropriate information fits the customer's needs so as to attract the customer effectively.

The above objects of the present invention are achieved by an information decision apparatus including: a target transactor finding part for finding target transactor in accordance with information of at least one promoting product; a transaction tendencies analyzing part for analyzing transactor's tendencies based on a transactor's transaction history for each of the target transactors; and an information decision part for deciding on appropriate information that fits the transactor's tendencies analyzed by the transaction tendencies analyzing part.

According to the present invention, it is possible to focus only on potential customers who may be interested in buying the promoting product. Further, transactor's tendencies based on a customer's purchasing history can be examined for each of the target customers. Furthermore, the decided-on appropriate information, which fits the analyzed transactor's tendencies, can be included in attractive information corresponding to each target customer.

### BRIEF DESCRIPTION OF THE DRAWINGS

Other objects, features and advantages of the present invention will become more apparent from the following detailed description when read in conjunction with the accompanying drawings, in which:

FIG. 1 shows a diagram illustrating a system configuration according to the embodiment of the present invention;

FIG. 2 shows a diagram illustrating a hardware construction according to the embodiment of the present invention;

FIG. 3 shows a diagram illustrating a customer table according to the embodiment of the present invention;

FIG. 4A shows a diagram illustrating a product type conversion table according to the embodiment of the present invention and FIG. 4B shows a diagram illustrating a product rank conversion table according to the embodiment of the present invention;

FIG. 5 shows a diagram illustrating a product introduction sentence table according to the embodiment of the present invention;

FIG. 6 shows a diagram illustrating the product information DB according to the embodiment of the present information;

FIG. 7 shows a flowchart diagram showing a broad structure of the sales support program according to the embodiment of the present invention;

FIG. 8 shows a flowchart diagram for explaining a process to retrieve potential products that are to be replaced, according to the embodiment of the present invention; and

FIG. 9 shows a flowchart diagram for explaining how a customer's purchasing trend is analyzed, according to the embodiment of the present invention.

### DESCRIPTION OF THE PREFERRED EMBODIMENT

A description will now be given of an embodiment of the present invention.

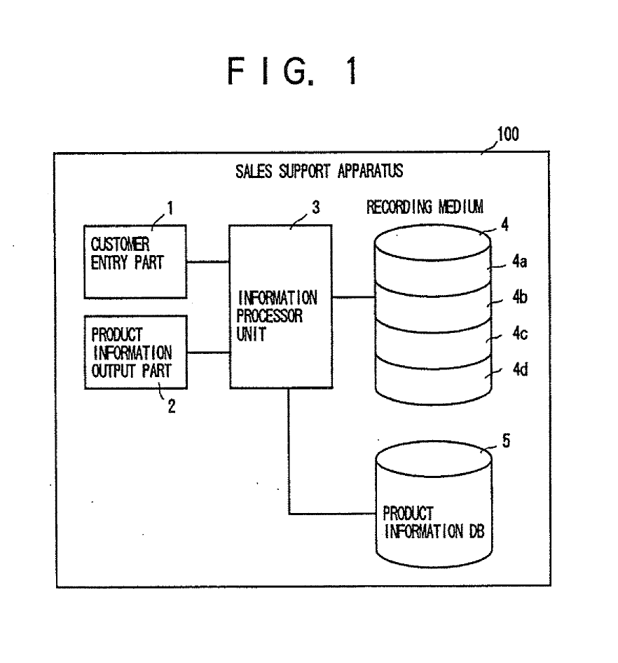

FIG. 1 shows a diagram illustrating a system configuration according to the embodiment of the present invention.

In this embodiment, it is assumed that the present invention is applied to a case of a personal computer business.

A sales support apparatus 100 corresponding to the information decision apparatus according to the embodiment includes a customer entry part 1, a product information output part 2, an information processor unit 3, a recording medium 4 and a product information database (DB) 5.

The information processor unit 3 controls all of the customer entry part 1, product information output part 2, recording medium 4, and product information DB 5 and executes a sales support program (described later) for finding only potential customers, choosing an appropriate new product or collected used product that fits the customer's purchasing trend, and outputting the appropriate product information to promote sale of the product.

Personal information from a user entry card coming with a personal computer (hereinafter called a PC), which card a customer sends to a computer manufacturer, is inputted from the customer entry part 1 and saved into the recording medium 4.

After the sales support program is executed, appropriate product information is generated based on the aforementioned personal information and is outputted from the product information output part 2.

Tables created, maintained and referred to by the sales support program are stored in the recording medium 4.

The product information DB 5 keeps information on all products and is referred to by the sales support program. The product information DB 5 may be timely maintained by another section and may be connected to the sales support apparatus through networks.

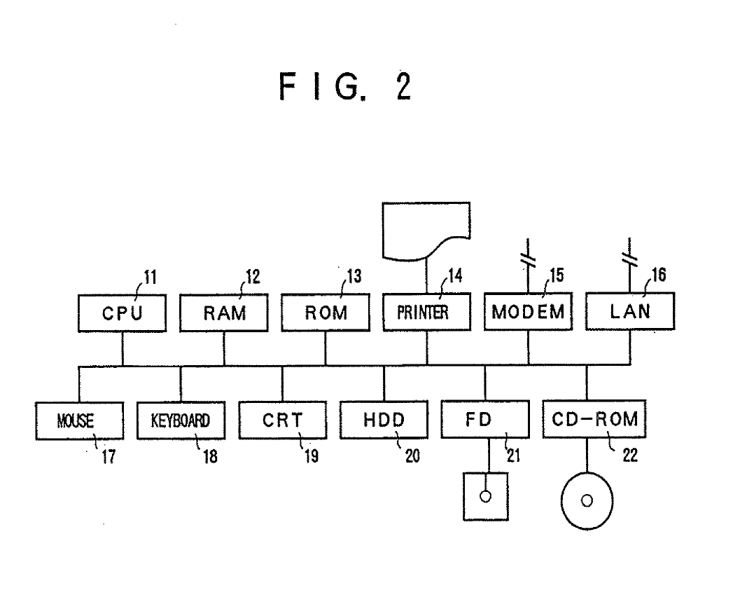

FIG. 2 shows a diagram illustrating a hardware construction according to the embodiment of the present invention.

As shown in FIG. 2, the sales support apparatus 100 is constructed with a CPU 11 to execute the sales support program, a RAM 12 to temporarily save the sales support program and needed data, a ROM 13 into which the program is loaded, a HDD 20 and a FD 21 to store necessary tables, a printer 14 to print out selected product information, a modem 15 to fax or e-mail customers the selected product information, a LAN 16 for remote operators to use the sales support system or to refer to the product information DB 5, a mouse 17 and a keyboard 18 to operate the sales support program or to input needed information, a CRT 19 to display information generated by the sales support program and to perform as an interface between operators and the same program, and a CD-ROM 22 where the program is stored. Of course, the medium storing the sales support program is not limited to the HDD 20, the FD 21 or the CD-ROM 22, but other computer readable recording media may be used.

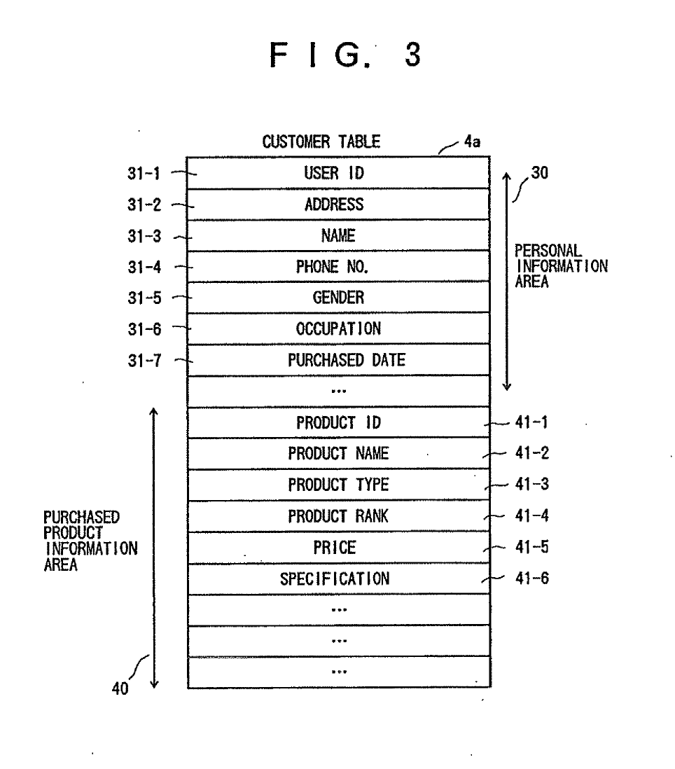

The tables in the recording medium 4 in FIG. 1 will now be explained with reference to FIGS. 3, 4A, 4B and 5.

FIG. 3 shows a diagram illustrating a customer table according to the embodiment of the present invention.

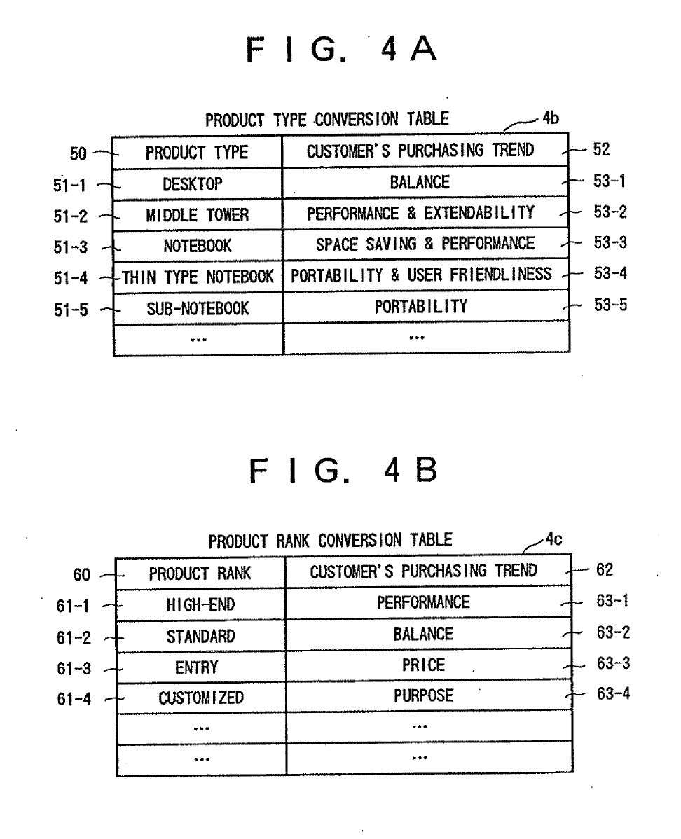

FIG. 4A shows a diagram illustrating a product type conversion table according to the embodiment of the present invention and FIG. 4B shows a diagram illustrating a product rank conversion table according to the embodiment of the present invention.

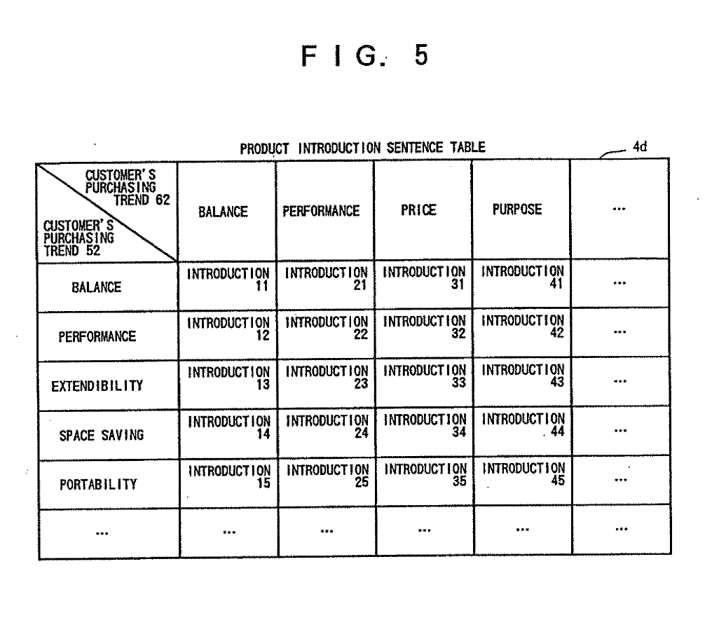

FIG. 5 shows a diagram illustrating a product introduction sentence table according to the embodiment of the present invention.

Referring to FIGS. 3, 4A, 4B and 5, the recording medium 4 includes the customer table 4a, the product type conversion table 4b, the product rank conversion table 4c, and the product introduction sentence table 4d. One record for one customer in the customer table 4a is shown in FIG. 3. One record has two areas, a personal area 30 and a purchased product information area 40. In a case of a plurality of customers, the customer table 4a has the same number of records as the number of customers.

The personal information area 30 is used to store a user ID 31-1, an address 31-2, a name 31-3, a phone number 31-4, a gender 31-5, an occupation 31-6, a purchased date 31-7 and so on.

The purchased product information area 40 is used to store a product ID 41-1, a product name 41-2, a product type 41-3, a product rank 41-4, a price 41-5, a specification 41-6 and so on.

Referring to FIG. 4A, the product type conversion table 4b has a product type 50 and a customer's purchasing trend 52.

The product type 50 includes a plurality of types: desktop 51-1, middle tower 51-2, notebook 51-3, thin type notebook 51-4, sub-notebook 51-5 and so on.

The customer's purchasing trend 52 includes a plurality of customer's purchasing trends: balance 53-1, performance and extendibility 53-2, space saving and performance 53-3, portability and user friendliness 53-4, portability 53-5 and so on.

A product type is converted into a customer's purchasing trend as follows: the desktop 51-1, the middle tower 51-2, the notebook 51-3, the thin type notebook 51-4, and the sub-notebook 51-5 are converted into the balance 53-1, the performance and extendibility 53-2, the space saving and performance 53-3, the portability and user friendliness 53-4, and the portability 53-5, respectively, in accordance with this order.

Referring to FIG. 4B, the product rank conversion table 4c has a product rank 60 and a customer's purchasing trend 62.

The product rank 60 includes a plurality of product ranks: high-end 61-1, standard 61-2, entry 61-3, customized 61-4 and so on.

The customer's purchasing trend 62 includes a plurality of customer's purchasing trends: performance 63-1, balance 63-2, price 63-3, purpose 64-4 and so on.

A product rank is converted into a customer's purchasing trend as follows: the high-end 61-1, the standard 61-2, the entry 61-3, and the customized 61-4 are converted into the performance 63-1, the balance 63-2, the price 63-3, the purpose 64-4, respectively, in accordance with this order.

In FIG. 5, trend items of the customer's purchasing trend 52 derived from the product types are arranged in the first column and trend items of the customer's purchasing trend 62 derived from the product ranks are arranged in the first row of the product introduction sentence table 4d. Then a combination of two kinds of trend items indicates an identical product introduction sentence. For example, when the customer's purchasing trend 52 shows “extendibility” and the customer's purchasing trend 62 shows “performance”, this combination indicates “introduction 23”. Thus, this “introduction 23” is included into direct mail.

The product information DB 5 will now be explained.

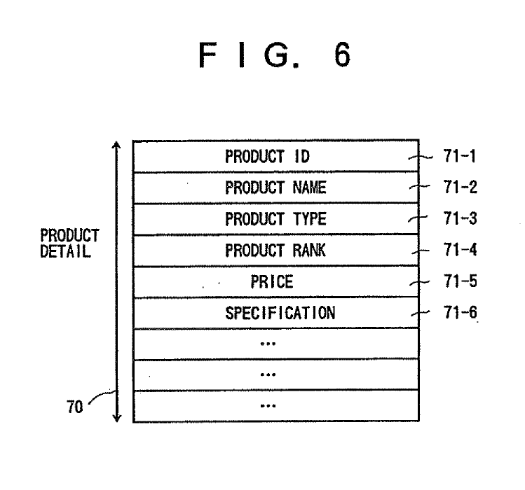

FIG. 6 shows a diagram illustrating the product information DB 5 according to the embodiment of the present information.

Referring to FIG. 6, one record as a product detail 70 consists of a product ID 71-1, a product name 71-2, a product type 71-3, a product rank 71-4, a price 71-5, a specification 71-6 and so on. The product information DB 5 manages a plurality of product details 70. The product information DB 5 is referred to due to find products to be offered for replacement demand.

The sales support program will now be explained.

A method for finding customers who purchased products to be replaced with new products and choosing product introduction sentences in FIG. 5 will be explained.

First, a customer's personal information including name, address, phone number, and product ID is inputted from the customer entry part 1 when a PC manufacturer receives the user entry card from the customer. The inputted personal information is stored by the information processor unit in accordance with the structure of the personal information area in the customer table 4a. Subsequently, necessary product information is retrieved by the product ID from the product information DB 5 and is stored into the customer table 4a in accordance with the structure of the purchased product information area 40. In the purchased product information area 40, it is assumed that the product type 41-3 may have data including a hardware type and a software installation method. The hardware type may indicate desktop, tower, notebook or the like. The software installation method may indicate pre-installed standard software, additional software, customized software or the like. It is also assumed that the product rank 41-4 may include data including a price or a performance rank. The performance rank may indicate high-end, standard, entry, customized or the like.

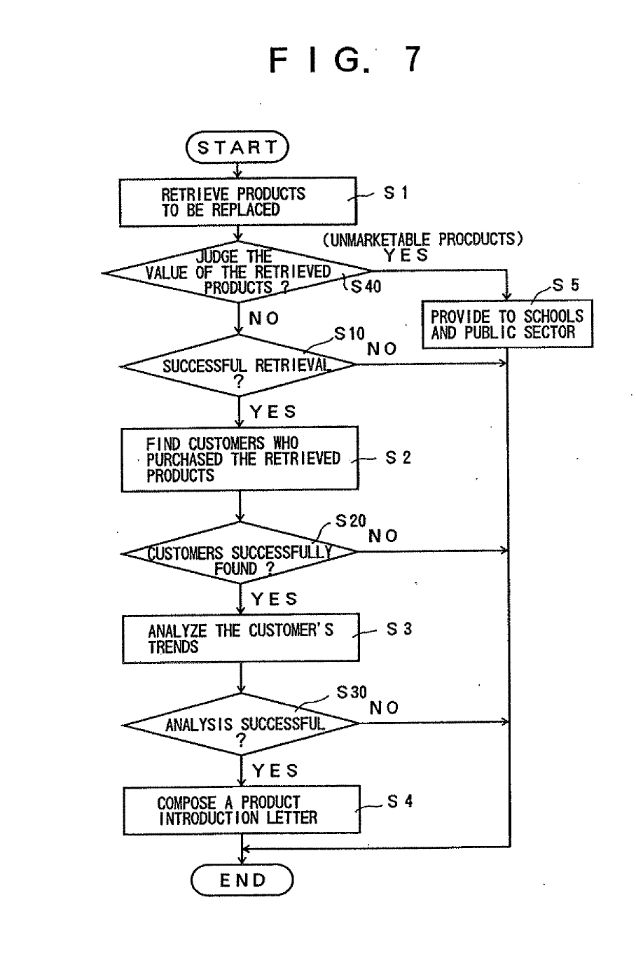

FIG. 7 shows a flowchart diagram showing a broad structure of the sales support program according to the embodiment of the present invention. The sales support program includes a step S1 to retrieve products to be replaced, a step S40 to judge the value of the retrieved products, a step S5 to provide the products to schools or the public sector, a step S10 to check the success in retrieving products, a step 32 to find customers who have previously purchased the retrieved products, a step S20 to check the success in finding customers, a step S3 to analyze the customer's purchasing trend, a step S30 to check the success in analyzing, and a step S4 to create a direct mail including product introductions.

To find customers who may replace their old PC, information on the potential PCs to be replaced are retrieved from the product information DB. Then, the product IDs or names of the potentially replaced PCs are obtained in the step S1.

Each of the potentially replaced PCs retrieved in the step S1 is judged as to whether its value is high enough to pay the cost of sales in the step S40. That is, when the PC is unmarketable, the step S5 is performed to provide the PC to a school or the public sector.

In the step S5, the information of the unmarketable PC is recorded and managed for providing the PC to a school to the public sector.

On the other hand, when the PC has market value, it is checked if the product IDs or names of the PCs are obtained successfully in the step S10. When the result of the checking is negative, the process is terminated. That is, there are no potential replaced PCs at this time. When the result is successful, the process performs the next step S2.

By searching for the product IDs or names of the products retrieved in the step S1, information of corresponding customers is selected from the customer table 4a in FIG. 3 in the step S2. Moreover to retrieve potential customers who may replace their PCs, the purchased date 31-7 of each selected customer is considered in the step S2. That is, when the purchased date 31-7 is 6 months or more than one year before the present date, the selected customer can be a potential customer. Then the customer's information is retrieved. Otherwise, the selected customer is not regarded as a potential customer.

In the step S20, it is checked whether the potential customers are found. When the result of the checking is negative, the process is terminated. That is, there is no potential customer at this time. When the result is successful, the process performs the next step S3.

From information of the potential customers, the purchasing trend of each potential customer is analyzed in accordance with the product type 41-3 and the product rank 41-4 in the customer table 4a in the step S3. That is, by using the product type conversion table 4b, the customer's purchasing trend 52 is obtained by converting the value of the product type 41-3. In addition, by using the product rank conversion table 4c, the customer's purchasing trend 62 is obtained by converting the value of the product rank 41-4. After analyzing the customer's purchasing trends, the combination of the analyzed customer's purchasing trends designates an identical product introduction sentence by using the product introduction sentence table 4d. It should be noted that the product type 41-3 and the product rank 41-4 might have a few different values.

In the step S30, it is checked whether two customer's purchasing trends are analyzed successfully. When the result of the checking is negative, the process is terminated. When the result is successful, the process performs the next step S4.

Accordingly, direct mail is composed with the designated introduction sentence for the potential customer in the step S4. It should be noted that a few different introduction sentences might be designated in the case in which the product type 41-3 or the product rank 41-4 has a few different values. Moreover, instead of composing direct mail, e-mail may be composed with the designated introduction sentence and be timely sent to the potential customer via the Internet.

The information designated in step S3 is not limited to the product introduction sentence but may be any other information.

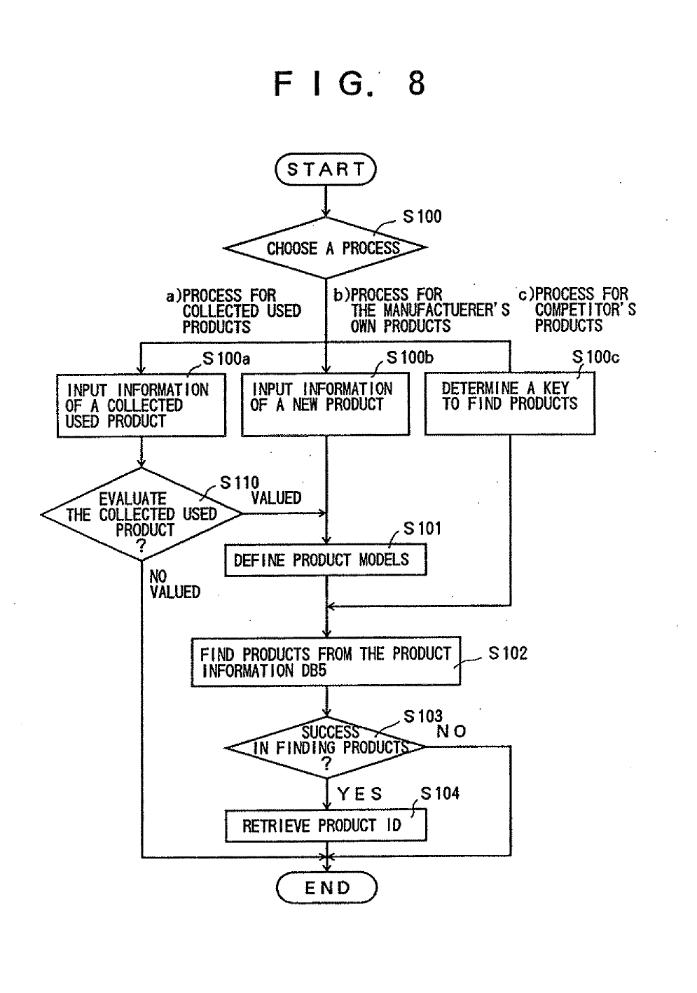

FIG. 8 shows a flowchart diagram for explaining a process to retrieve potential products that are to be replaced, according to the embodiment of the present invention.

In FIG. 8, the step S1 includes a step S100 to choose a process, a step S100a to input information of a collected used product, a step S110 to evaluate the collected used product, a step S100b to input information of a new product, a step S100c to determine a key to find products, a step S101 to define product models for the replacement demand, a step S102 to find products from the product information DB 5, a step S103 to check success in finding products, and a step S104 to retrieve product IDs. It should be noted that the step S1 has three sub-processes: a sub-process for a collected used product; a sub-process for the manufacturer's own product; and a sub-process for a competitor's product.

One of the three sub-processes is selected by an operator in the step S100. When the sub-process for a collected used product is selected, the step S100a is performed to input information of a collected used product.

The inputted information of the collected used product by the operator is saved into the product information DB 5 in the step S100a.

Subsequently, the collected used product is evaluated in the step S110. When the collected used product is a valued product, the step S101 is performed to find products that can be replaced with the collected used product. When the collected used product has no value, the process to retrieve potential products is terminated with information of “NO VALUE”.

When the sub-process for the manufacturer's own product is selected in the step S100, the step S100b is performed to register a new product. The information of the new product is saved into the product information DB 5 in S100b. The sub-process for the manufacturer's own product may be selected especially when the manufacturer starts to promote its own new product.

After the new product is registered, the step S101 is performed to find products that can be replaced with the new product.

In the step S101, product models are defined based on the information from the sub-process for a collected used product or the sub-process for the manufacturer's own product. That is, the product models that have lower performance than the used product or the new product are defined as find keys to find potential customers who may replace their PCs.

When the sub-process for a competitor's product is selected in the step S100, the step S100c is performed to find a product of the manufacturer that has lower performance than the competitor's product. That is, the manufacturer's own product may be replaced with the competitor's product. In addition, customers who have that manufacturer's own product can be targeted by the competitor. To avoid losing the manufacturer's own customers, this sub-process may be chosen and the step S100c is performed especially when a competitor starts to promote its new product.

In the step S100c, the operator determines a model of the manufacturer's own product that has lower performance than the competitor's product as a find key and inputs information of the manufacturer's own product: for example, OS's (Operation System) version and level of the manufacturer's own product.

By using the find key, products that can be replaced are searched for and retrieved from the product information DB 5 in the step S102.

In the step S103, it is checked whether the step S102 found products successfully. When the step S102 succeeds, product IDs or product names are retrieved in the step S104. When the step S102 fails, the process is terminated.

After product IDs or product names that can be replaced with the used product, the new product, or the competitors' product are retrieved, the process (the step S1) to retrieve potential products is terminated. Accordingly, this process can concentrate on the potential product that may be replaced. Especially in a case in which the manufacturer maintains many kinds of products, this process performs effectively.

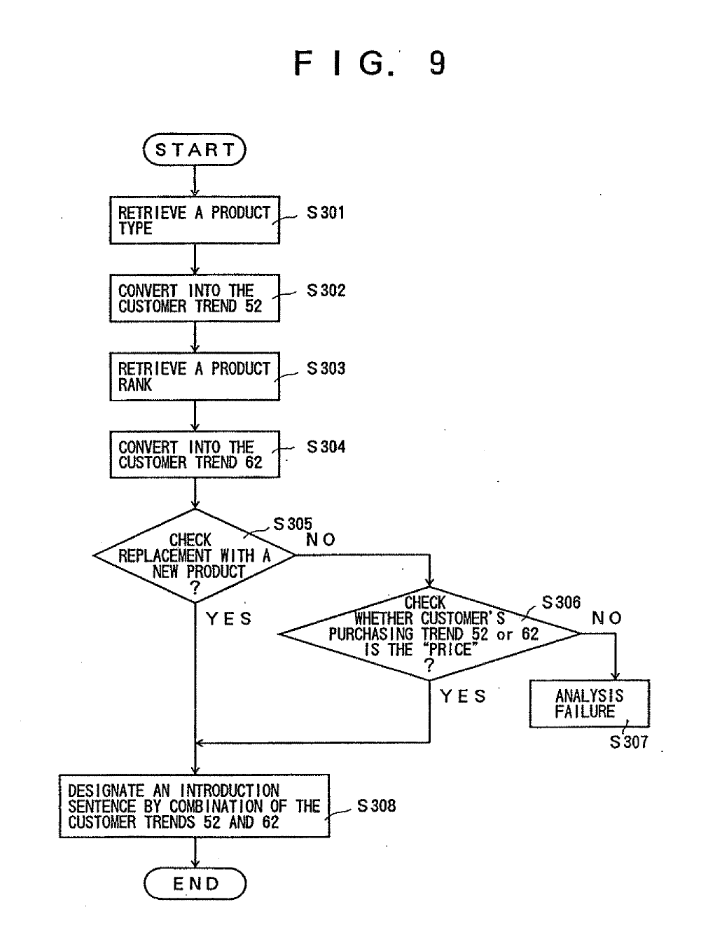

FIG. 9 shows a flowchart diagram for explaining how a customer's purchasing trend is analyzed, according to the embodiment of the present invention.

Referring to FIG. 9, the step S3 to analyze the customer's purchasing trend shown in FIG. 7 includes a step S301 to retrieve a product type, a step S302 to convert the product type into the customer's purchasing trend 52, a step S303 to retrieve a product rank, a step S304 to convert the product rank into the customer's purchasing trend 62, a step S305 to check a replacement with a new product, a step S306 to check if the customer's purchasing trend 52 or 62 is the “price”, a step S307 for an analysis failure, and a step S308 to designate an introduction sentence by a combination of the customer's purchasing trends 52 and 62.

The step S3 is performed when potential customers are retrieved successfully. From information of each potential customer selected from the customer table 4a, the product type 41-3 is retrieved. It is assumed that a customer “A” is selected in the step S2 and purchased a valuable PC with high-level functions, which PC is called a middle-tower-type high-end model. In this case, the product type 41-3 shows the “middle tower”.

Subsequently, the “middle tower” that is the value of the product type 41-3 is converted into the customer's purchasing trend 52 by using the product type conversion table 4b in the step S302. That is, based on the aforementioned assumption, one of the items listed in the product type 50 is searched for, which item is equal to the product type 41-3 of the customer “A”. Accordingly, the middle tower 51-2 is selected and the performance and extendibility 53-2 is retrieved from the items listed in the customer's purchasing trend 52. Thus, the customer “A” is analyzed from the product type as tending to require two values: “performance” and “extendibility”.

The customer “A” is also analyzed from another view. It is supposed that the product rank 41-4 for the customer “A” shows “high-end”. In the step S303, the value of the product rank 41-4 is retrieved.

Subsequently, “high-end”, which is the value of the product rank 41-4, is converted into the customer's purchasing trend 62 by using the product type conversion table 4c in the step S304. That is, one of the items listed in the product rank 60 is searched for, which item is equal to the product rank 41-4 of the customer “A”. Accordingly, high-end 61-1 is selected and the performance 63-1 is retrieved from the items listed in the customer's purchasing trend 62. Thus, the customer “A” is analyzed from the product rank as tending to require the value, “performance”.

In the step S305, it is checked whether the sub-process for the manufacturer's own product or for the competitor's product is chosen in the step S100 as shown in FIG. 8. When the process is for a new product, the step S306 is performed to designate an introduction sentence. When the sub-process for a collected used product is chosen in the step S100, the step S306 is performed to check whether the customer emphasizes a price.

In a case in which customers tend to emphasize the product price, the customers are likely to purchase used products that perform better than their PCs. Thus, when the sub-process for a collected used product is chosen, potential customers are retrieved from all customers who purchased retrieved products in the step S2 as shown in FIG. 7 in a condition in which the customer's purchasing trend 52 or 62 indicates the “price” in the step S306. When the potential customers are retrieved successfully, the step S308 is performed. When there is no potential customer for the collected used product, the step S307 is performed.

For each potential customer, at least one introduction sentence is designated by a combination of the customer's purchasing trends 52 and 62 from the product introduction sentence table 4d in FIG. 5. In the case of the customer “A”, from the customer's purchasing trends 52 and 62, one combination of the performance row and the performance column designates the introduction 22 and another combination of the extendibility row and the performance column designates the introduction 23 with reference to FIG. 5. For this customer “A”, two introduction sentences are indicated. Accordingly, the two designated introduction sentences are included in direct mail.

Therefore, direct mail is not limited to including only one introduction sentence but may include a plurality of introduction sentences in accordance with the customer's purchasing trends 52 and 62 in the step S3. Furthermore, more than just one the product type and the product rank is applied to analyze customer's purchasing trends. The other information or combinations of many kinds of information related to a customer or product may be applied to analyze effectively. Moreover, this process can make suitable and more attractive product introduction sentences corresponding to each of potential customers, which suitability and attractiveness help the sales promotion effectively.

As mentioned above, the present invention can provide appropriate and timely product information to each potential customer every time the manufacturer or its competitor starts to promote new products or every time the manufacturer collects used products.

In addition, with regard to providing information that fits the customer's needs, provided information is not limited to the PC business. The present invention can apply to other business dealings with other kinds of products, such as automobiles, and can apply to real estate businesses and financial institution. Moreover, the present invention can perform effectively for service businesses, for example, stuffing service businesses, magazine advertising agencies, banking services, stock market information providers, housing businesses, appraisal businesses, travel agencies, delivery services, and so on. Furthermore, software products, programs or data that the present invention applies to may be stored on computer readable recording media or provided via the Internet.

The present invention is not limited to the specifically disclosed embodiments, variations and modifications, and other variations and modifications may be made without departing from the scope of the present invention.

The present application is based on Japanese priority application No. 10-355046 filed on Dec. 14, 1998, the entire contents of which are hereby incorporated by reference.

1-21. (canceled)

22. An information decision computing apparatus, comprising:
a customer information recording area recording customer information indicating purchase information including a product type and a product rank, the purchase information concerning a product which a customer purchased, by corresponding to purchase information concerning the customer;
a product type conversion information recording area recording product type conversion information in which the product type corresponds to a first purchasing trend information indicating a first purchasing trend of the customer;
a product rank conversion information recording area recording a product rank conversion information in which the product rank corresponds to second purchasing trend information indicating a second purchasing trend of the customer;
an introduction sentence information recording area recording introduction sentence information corresponding to a combination of the first purchasing information and the second purchasing information corresponds to an introduction sentence concerning a promotion product;
a purchasing trend analyzing part including a first conversion part converting the product type into the first purchasing trend information by searching in the product type conversion information area by using the product type of the product which the customer purchased and obtaining the first purchasing trend information corresponding to the product type, and a second conversion part converting the product rank into the second purchasing trend information by searching in the product rank conversion information area by using the product rank of the product which the customer purchased and obtaining the second purchasing trend information corresponding to the product rank, whereby purchasing trends of the customer are analyzed; and
an introduction sentence determining part searching in the introduction sentence information recording area by using the combination of the first purchasing information and the second purchasing information converted by the purchasing trend analyzing part, and providing at least one introduction sentence from the introduction sentence information corresponding to the combination.

23. The information decision computing apparatus as claimed in claim 22, further comprising:
a product registration information recording area recording product registration information for managing registration information corresponding to product identification information for each product;
a replacement subject product searching part searching for the registration information indicating a product having lower performance than the promotion product in the product registration information recording area; and
a customer searching part determining the product specified in the product identification information in the product registration information searched by the replacement subject product searching part as a replacement subject product, and searching for the customer who purchased the replacement subject product by searching for the product identification information of the replacement subject product from the customer information by obtaining the customer information from the customer information recording area.

24. A method of marketing products, comprising:
analyzing purchase history information of customers with respect to a first product;
identifying customers who are likely to purchase a second product replacing the first product based on the analysis; and
presenting individualized information to the identified customers including an introductory sentence indicating a corresponding interest of each of the customers in the second product using a result of the analysis.

25. A method for marketing products, comprising:
generating an introductory sentence describing a product to correspond to a transaction tendency of each customer determined from a purchase history of each customer; and
providing promotional information for the product including the introductory sentence to at least one customer, where the introductory sentence is identical to a purchase trend indicated in the purchase history of each customer.

26. A computer-implemented method, comprising:
analyzing transaction histories of a first customer and a second customer based on purchasing tendencies thereof, said histories indicating a tendency of both the first customer and the second customer to purchase a particular product;
identifying the product for promotion based on said purchasing tendencies; and
providing a promotion having a first sentence related to the product to the first customer and a second sentence related to the product to the second customer, where said first sentence and said second sentence identify different characteristics of the product.
